(19) United States
(12) Patent Application Publication
(10) Pub. No.: US 2024/0086991 A1
(43) Pub. Date: Mar. 14, 2024

(54) PRODUCT RECOMMENDATION METHOD, APPARATUS, AND DEVICE AND PRODUCT CUSTOMIZATION METHOD, APPARATUS, AND DEVICE IN LIVE ROOM

(71) Applicant: SHANGHAI BILIBILI TECHNOLOGY CO., LTD., Shanghai (CN)

(72) Inventor: Rongyue BEI, Shanghai (CN)

(21) Appl. No.: 18/367,396

(22) Filed: Sep. 12, 2023

(30) Foreign Application Priority Data
Sep. 13, 2022 (CN) 202211111587.4

(51) Int. Cl. G06Q 30/0601; G07C 13/00

(52) U.S. Cl. CPC G06Q 30/0631; G06Q 30/0621; G07C 13/00

(57) ABSTRACT

The present disclosure techniques for implementing livestreaming. The techniques comprise generating a candidate product library associated with a live room, wherein the candidate product library comprises a plurality of candidate products, and wherein the live room is configured to implement livestreaming by a streamer terminal device associated with an online streamer; generating recommendation indicators corresponding to the plurality of candidate products based on historical interaction data of the plurality of candidate products; causing to present the recommendation indicators on the streamer terminal device; selecting at least one customizable product from the plurality of candidate products based at least in part on the recommendation indicators; configuring customizable information of the at least one customizable product; and adding the at least one customizable product configured with the customizable information to the live room for pushing to one or more audience terminal devices during a livestreaming process.

### CROSS-REFERENCE TO RELATED APPLICATION

The present application claims priority to Chinese Patent Application No. 202211111587.4, filed on Sep. 13, 2022, which is incorporated herein by reference in its entirety.

### BACKGROUND

With popularization of Internet technologies, network livestreaming is being accepted and loved by more people. In network livestreaming, an online streamer can provide an audience with multimedia content and receive feedback from the audience by using a live platform. Improvements in livestreaming scheduling are desired.

### SUMMARY

The present disclosure provides a product recommendation method and apparatus in a live room, a product customization method and apparatus in a live room, an electronic device, a computer-readable storage medium, and a computer program product.

According to an aspect of the present disclosure, a product recommendation method in a live room is provided, including: generating a candidate product library for the live room, where the candidate product library includes a plurality of candidate products; selecting at least one customizable product from the plurality of candidate products; configuring customizable information of the at least one customizable product; and adding the at least one customizable product configured with the customizable information to the live room, to perform product customization based on a product customization request.

According to an aspect of the present disclosure, a product customization method in a live room is provided, including: obtaining at least one customizable product for the live room; and initiating a product customization request, where the product customization request includes a first customized product selected from the at least one customizable product and first customization information of the first customized product.

According to an aspect of the present disclosure, a product recommendation apparatus in a live room is provided, including: an obtaining unit, where the obtaining unit is configured to generate a candidate product library for the live room, and the candidate product library includes a plurality of candidate products; a selection unit, where the selection unit is configured to select at least one customizable product from the plurality of candidate products; a configuration unit, where the configuration unit is configured to configure customizable information of the at least one customizable product; and a putaway unit, where the putaway unit is configured to add the at least one customizable product configured with the customizable information to the live room, to perform product customization based on a product customization request.

According to an aspect of the present disclosure, a product customization apparatus in a live room is provided, including: an obtaining unit, where the obtaining unit is configured to obtain at least one customizable product for the live room; and a customization unit, where the customization unit is configured to initiate a product customization request, and the product customization request includes a first customized product selected from the at least one customizable product and first customization information of the first customized product.

According to another aspect of the present disclosure, an electronic device is further provided, including: at least one processor; and a memory communicatively connected to the at least one processor, where the memory stores a computer program, and the foregoing method is implemented when the computer program is executed by the at least one processor.

According to another aspect of the present disclosure, a non-transitory computer-readable storage medium storing a computer program is further provided, where the foregoing method is implemented when the computer program is executed by a processor.

According to another aspect of the present disclosure, a computer program product is further provided, including a computer program, where the foregoing method is implemented when the computer program is executed by a processor.

According to one or more embodiments of the present disclosure, a recommended product may be selected for an audience in the live room in a targeted manner by selecting the customizable product from the candidate products. In addition, the customizable information of the customizable product is configured and the customizable product is added to the live room, so that a user can be allowed to customize a product, thereby further improving a degree of matching between a product in the live room and the audience, and increasing a product transaction conversion rate of the live room.

It should be understood that the content described in this part is not intended to identify key or important features of the embodiments of the present disclosure, nor is it intended to limit the scope of the present disclosure. Other features of the present disclosure will be readily understood based on the following specification.

### BRIEF DESCRIPTION OF DRAWINGS

The accompanying drawings show examples of the embodiments and constitute a part of this specification, and together with the descriptions of this specification are used to describe example implementations of the embodiments. The illustrated embodiments are merely used for illustrative purposes and are not intended to limit the scope of the claims. In all the accompanying drawings, the same reference numerals refer to similar but not necessarily the same elements.

FIG. 1 is a flowchart of a product recommendation method in a live room according to an embodiment of the present disclosure.

FIG. 2 is a schematic diagram of an online streamer product selection interface according to an embodiment of the present disclosure.

FIG. 3 is a flowchart of a product recommendation method in a live room according to an embodiment of the present disclosure.

FIG. 4a and FIG. 4b are schematic diagrams of product information import interfaces according to an embodiment of the present disclosure.

FIG. 5 is a flowchart of a product recommendation method in a live room according to an embodiment of the present disclosure.

FIG. 6 is a flowchart of a product customization method in a live room according to an embodiment of the present disclosure.

FIG. 7 is a schematic diagram of a product customization service interface according to an embodiment of the present disclosure.

FIG. 8 is a schematic diagram of a product voting interface according to an embodiment of the present disclosure.

FIG. 9 is a block diagram of a product recommendation apparatus in a live room according to an embodiment of the present disclosure.

FIG. 10 is a block diagram of a product customization apparatus in a live room according to an embodiment of the present disclosure.

FIG. 11 is a block diagram of an electronic device according to an embodiment of the present disclosure.

### DESCRIPTION OF EMBODIMENTS

The following provides descriptions of the example embodiments of the present disclosure with reference to the accompanying drawings, and the descriptions include various details of the embodiments of the present disclosure to facilitate understanding and should be considered merely as examples. Therefore, a person of ordinary skill in the art should recognize that various changes and modifications may be made to the embodiments described herein without departing from the scope of the present disclosure. Similarly, for clarity and simplicity, descriptions of the well-known functions and structures are omitted in the following descriptions.

In the present disclosure, unless otherwise stated, the terms “first”, “second”, and the like are used to describe various elements, and are not intended to limit a positional relationship, a temporal relationship, or an importance relationship between these elements. Such terms are merely used to distinguish one element from another element. In some examples, a first element and a second element may indicate a same instance of the elements. In some cases, the first element and the second element may refer to different instances based on context descriptions.

The terms used in the descriptions of various examples in the present disclosure are merely intended to describe specific examples and are not intended to limit the present disclosure. Unless otherwise explicitly stated in the context, if a quantity of elements is not specifically limited, there may be one or more elements. In addition, the terms “and/or” used in the present disclosure cover any and all possible combinations of listed items.

An applicant notices that, with popularization of Internet technologies, network livestreaming is being accepted and loved by more people. There are also many professional and influential online streamers. An online streamer needs sufficient inputs to continuously output high-quality livestreaming content, for example, capital inputs and energy inputs. Creation costs of the online streamer can be effectively shared by selling a product in a live room through “live commerce” and the like. This part of revenue can also stimulate the online streamer to further output high-quality content. However, the “live commerce” product selling mode also brings about some problems, or even raises concerns among some fans of the online streamer. For example, quality of a product sold in the live room is defective, or a degree of matching between a product sold in the live room and a requirement of an audience user is not high.

To resolve the foregoing technical problems, a product recommendation method in a live room is provided according to one or more embodiments of the present disclosure. In this method, customizable information of a customizable product is configured and the customizable product is added to the live room, so that a user can be allowed to customize a product, thereby further improving a degree of matching between a product recommended in the live room and an audience, and increasing a product transaction conversion rate of the live room.

In general, the present disclosure provides a product recommendation method in a live room, to implement targeted product recommendation used in the live room, thereby improving a degree of matching between a sold product and a requirement of an audience user associated with audience terminal device(s), and increasing a transaction conversion rate.

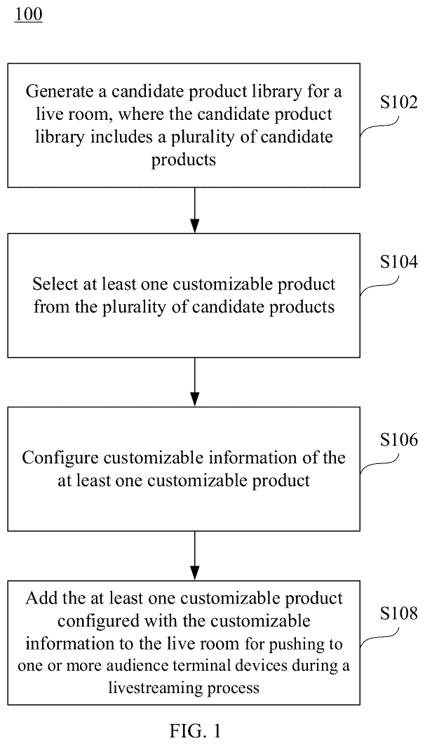

FIG. 1 is a flowchart of a product recommendation method 100 in a live room according to an embodiment of the present disclosure.

As shown in FIG. 1, the method 100 includes: step S102: generating a candidate product library for the live room based on monitoring interaction data associated with products, where the candidate product library includes a plurality of candidate products, the live room is configured to implement livestreaming by a streamer terminal device associated with an online streamer; step S104: selecting at least one customizable product from the plurality of candidate products; step S106: configuring customizable information of the at least one customizable product; and step S108: adding the at least one customizable product configured with the customizable information to the live room for pushing to one or more audience terminal devices during a livestreaming process.

When the method 100 is performed at an online streamer terminal device, the adding the at least one customizable product configured with the customizable information to the live room may include: initiating a push request corresponding to the at least one customizable product to a server computing system, so that the server computing system adds the at least one customizable product to a database of the live room; and pushing the at least one customizable product to a user terminal device of the live room through broadcasting.

Therefore, the customizable information of the customizable product is configured and the customizable product is added to the live room, so that a user can be allowed to customize a product, thereby further improving a degree of matching between the product in the live room and a requirement of the user, and increasing a product transaction conversion rate of the live room.

According to some embodiments, the customizable information includes at least one of text information, picture information, product size information, or product color information. Expected text may be added to the product for the user by customizing the text information, and an expected picture may be added to the product for the user by customizing the picture information. In addition, the product size information and the product color information may be customized to replace a size and an appearance color of the product for the user, thereby expanding selection space of the user.

In some embodiments, the customizable information is configured by an online streamer in the live room. For example, the online streamer in the live room can select one or more of the text information, the picture information, the product size information, and the product color information. The online streamer can further determine options that each kind of customizable information can provide, for example, provide optional text content, a text quantity range, filtered text, and the like for customizing the text information, and provide optional image content, an image size range, and the like for customizing the picture information. The customizable product configured with the customizable information is added to the live room for customization and purchase by the user in the live room.

In some embodiments, the candidate product library that includes the plurality of candidate products and that is for the live room may be determined in a manual manner, an algorithm manner, a manual-algorithm combined manner, or another manner. Specifically, according to some embodiments, the plurality of candidate products in the candidate product library are determined based on historical interaction data of the plurality of candidate products. Therefore, the user in the live room can be provided with a targeted high-quality candidate product based on the historical interaction data, thereby improving quality of a product that is actually put on sale in the live room and a user matching degree.

The candidate product library may be a product database of a live platform, or may include some products that meet a preset condition in the product database of the live platform. For example, the candidate product library includes products whose historical interaction data meets a preset condition in the product database of the live platform.

In some embodiments, the historical interaction data may be historical interaction data in a preset time period, for example, historical interaction data in T days that is preset before a current time, where T is a positive integer. It may be understood that a length of the preset time period may be adjusted based on an actual requirement, for example, adjusted to a plurality of hours, a plurality of days, or a plurality of weeks.

According to some embodiments, the historical interaction data of the plurality of candidate products includes at least one of exposure rates, favorite rates, click conversion rates, and user feedback information of the plurality of candidate products. The exposure rate may indicate a frequency of the candidate product appearing in the live room, the live platform, or another sales platform or advertisement platform; the favorite rate may indicate a proportion of audience users collecting the candidate product in the live room, the live platform, or another platform; and the click conversion rate may indicate a proportion of audience users ordering and purchasing the candidate product after clicking and browsing the candidate product in the live room, the live platform, or another platform.

Therefore, the historical interaction data can be used to reflect a concern and purchase intention of the user on each candidate product in a historical period. The historical interaction data can represent a degree of acceptance of the candidate product by the user. In addition, quality and accuracy of recommending a product (for example, the foregoing customizable product) by the online streamer can be improved by determining the candidate products based on the historical interaction data.

According to some embodiments, the user feedback information includes purchase feedback information of each of the plurality of candidate products and evaluation feedback information of the online streamer in the live room for each of the plurality of candidate products. The purchase feedback information may be an evaluation made after the user receives and uses the product, and the evaluation feedback information of the online streamer in the live room for the product may be a feedback obtained by the online streamer from the user in the live room, for example, a bullet-screen comment in the live room, or may be a feedback of the online streamer for a sales status of the product in the live room.

In some embodiments, the user feedback information may be identified as a plurality of keywords or phrases by using, for example, an artificial intelligence method, where a keyword or a phrase that meets a preset standard may be determined as a recommendation reason of the candidate product, for example, a keyword or a phrase that appears at a frequency that exceeds a predetermined threshold, or a keyword or a phrase that appears at a frequency whose growth rate exceeds a predetermined threshold.

In some embodiments, when the online streamer selects the customizable product from the plurality of candidate products, the online streamer can simultaneously see recommendation reasons of the candidate products, and select a plurality of customizable products from the plurality of candidate products based on the recommendation reasons and recommendation scores, to recommend the plurality of customizable products to an audience user in a livestreaming process.

Therefore, because the historical interaction data includes the user feedback information, the online streamer can be provided with a more intuitive product recommendation reason, thereby helping the online streamer select a product in a more targeted manner. The user feedback information includes: a feedback from the user, which can reflect use experience of a corresponding candidate product; and a feedback from the online streamer, which can reflect sales experience of the corresponding candidate product. Therefore, the user feedback information can be used to help the online streamer fully understand a sales feature and a use feature of the corresponding candidate product, and help the online streamer select the product in a more targeted manner. In addition, the online streamer alternatively selects a high-quality product in a manual-algorithm combined manner, to recommend the high-quality product to the user in the live room. In the livestreaming field, an online streamer often has some knowledge about a user in a live room of the online streamer. This combination manner can be used to effectively avoid a limitation of a product recommendation algorithm, and ensure quality of a product that is finally recommended to the user and a specific user matching degree.

According to some embodiments, the selecting at least one customizable product from the plurality of candidate products in step S104 includes: obtaining recommendation indicator information of the plurality of candidate products based on the historical interaction data; and selecting the at least one customizable product from the plurality of candidate products based on the recommendation indicator information of the plurality of candidate products. Therefore, a clear recommendation indicator is provided to simplify a procedure of selecting the customizable product.

In some embodiments, the recommendation indicator may be a recommendation score or a recommendation grade.

According to some embodiments, the recommendation indicator information includes a recommendation score and/or a recommendation reason. In other words, a specific recommendation score and/or a detailed recommendation reason may be simultaneously provided, so that it is convenient for the online streamer to quickly master recommendation degrees and features of different products, and to select the customizable product for the user in the live room in a targeted manner.

In some embodiments, in addition to determining the plurality of candidate products in the candidate product library based on the historical interaction data, the plurality of candidate products in the candidate product library may alternatively be determined based on a real-time user portrait in the livestreaming process. For example, according to some embodiments, the candidate product library is obtained based on at least an associated user portrait of the live room. Therefore, the candidate product library is adjusted based on a situation in the live room, and a degree of matching between the candidate product and the user is improved.

In some embodiments, the plurality of candidate products in the candidate product library may be determined based on both the historical interaction data and the associated user portrait of the live room. Specifically, in some embodiments, the product recommendation method in a live room for a user may include: determining a recommendation indicator (for example, including a recommendation score and/or a recommendation reason) of each of the plurality of candidate products based on the historical interaction data of the plurality of candidate products in the candidate product library for the live room; selecting a plurality of customizable products from the plurality of candidate products based on at least the recommendation indicator by the online streamer in the live room; obtaining the associated user portrait of the live room; and updating the candidate product library based on the associated user portrait of the live room.

Therefore, the recommendation score and the recommendation reason of the candidate product can be determined, to help the online streamer in the live room select a currently popular product, thereby improving quality of recommending a product by the online streamer. In addition, the candidate product library can be updated based on the associated user portrait of the live room, thereby further helping the online streamer select a product that has a high degree of matching with a requirement of an audience user, and increasing a product transaction conversion rate in the live room.

In some embodiments, the online streamer may be further provided with more targeted options. Specifically, the online streamer may screen the plurality of candidate products according to a preset rule to obtain a screened product list, and select a plurality of recommended products from the screened product list based on at least the recommendation indicator (which may include a recommendation score and/or a recommendation reason).

Therefore, the online streamer can actively screen the candidate products. In particular, in the livestreaming process, the online streamer may want to recommend specific types of products based on interaction content between the online streamer and the user. In this case, the online streamer may quickly screen the candidate products according to the preset rule, to obtain a product of a type that the online streamer wants to recommend.

In some embodiments, the preset rule includes a preset rule for at least one of putaway time information, price range information, recommendation reason information, and user type information. The putaway time information may include at least one of a time at which the product is imported into the live platform, a release time of the product, a production time of the product, and the like. The price range information may include a plurality of preset price ranges such as “less than 20 yuan”, “20 yuan to 50 yuan”, and “50 yuan to 100 yuan”. The recommendation reason information may include a plurality of preset recommendation reason labels, and the user type information may include a plurality of target user features. Therefore, the online streamer can screen the candidate products according to at least one preset rule, to obtain a screened product list that meets the preset rule, and recommend a product (for example, the customizable product) to the user in a more target manner.

In some embodiments, the determining a recommendation indicator of each of the plurality of candidate products based on the historical interaction data of the plurality of candidate products in the candidate product library for the live room and selecting a plurality of products from the plurality of candidate products based on at least a recommendation score by the online streamer in the live room may be completed before the online streamer starts livestreaming. The obtaining the associated user portrait of the live room and updating the candidate product library based on the associated user portrait of the live room may be completed in the livestreaming process of the online streamer.

For example, before the online streamer starts livestreaming, the online streamer may first select, from the plurality of candidate products, a product whose recommendation indicator meets a preset standard as a recommended product in the live room. After the online streamer starts livestreaming, the plurality of candidate products may be updated by obtaining the associated user portrait of the live room. In the livestreaming process, the online streamer may perform selection on the plurality of updated candidate products, to add, delete, or replace a selected recommended product.

According to some embodiments, the associated user portrait of the live room is determined based on historical behavior data of an intersected user between fan users of the live room and real-time viewers of the live room. For example, an associated user in the live room may be an intersection between fans in the live room and users currently watching livestreaming. A current associated user portrait for the live room may be determined based on the intersection. By using this method, user composition of the live room can be accurately determined, and a more precise user portrait can be constructed for these users.

In the livestreaming process, the real-time (or quasi-real-time, that is, there is a specific delay) viewers of the live room vary with time. Data corresponding to the real-time viewers may be obtained by using stream transmission technologies such as Kafka and SparkStreaming. The associated user portrait of the live room can be more accurately determined by performing an intersection operation on the fan users of the live room and the real-time viewers of the live room, to recommend a more precise high-quality product.

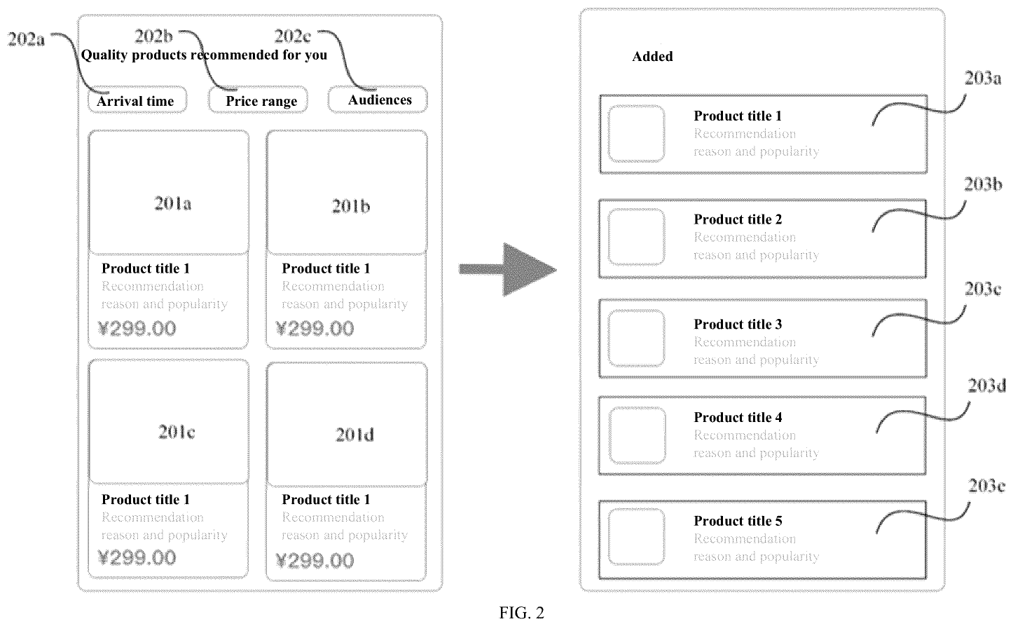

For example, FIG. 2 is a schematic diagram of an online streamer product selection interface according to an embodiment of the present disclosure.

As shown in FIG. 2, a left interface is an example of the candidate product library for the live room, and includes a plurality of candidate products 201a, 201b, 201c, and 201d. Each product has a product title, a recommendation reason, and popularity of the product. The recommendation reason may be determined based on the user feedback information of the candidate product, and may be a keyword or a phrase determined based on the purchase feedback information of the user and the evaluation feedback information of the online streamer in the live room. The popularity may be a score representing a current recommendation degree of the candidate product, for example, the recommendation score determined based on the historical interaction data of the candidate product. In some embodiments, a higher recommendation score indicates that the candidate product is more popular, and it is recommended that the online streamer selects the candidate product as a recommended product in the live room.

The interface of the candidate product library for the live room further includes three selectable objects 202a, 202b, and 202c, which respectively correspond to screening the candidate products according to three preset rules (namely, an arrival time, a price range, and a population). The online streamer may select one or more of the three preset rules. A screened candidate product may be different from the candidate products 201a, 201b, 201c, and 201d based on a selected preset rule.

The online streamer may select one or more candidate products from a plurality of candidate products (for example, 201a, 201b, 201c, and 201d) as recommended products and the recommended products are added to a recommendation list. As shown in FIG. 2, a right interface is an example of the recommendation list of the live room, and the recommendation list already includes recommended products 203a, 203b, 203c, 203d, and 203e that are selected and added by the online streamer. Similar to the candidate products in the candidate product library, the recommended products in the recommendation list each may also carry a product title, a recommendation reason, and popularity of the product. The recommended products in the recommendation list are recommended to an audience user in the live room in the livestreaming process for user operations such as purchasing.

It may be understood that the online streamer product selection interface may alternatively include other quantities of candidate products, recommended products, and selectable objects to implement the steps described in the foregoing method.

It may be understood that, in addition to the product customized and purchased by the user in the live room, the product selected and recommended in the foregoing method may be a product that is desired to be pushed to the user in the live room for any purpose, for example, a product desired to be pushed to the user in the live room for customization, a product desired to be pushed to the user in the live room for purchasing, or a product desired to be pushed to the user in the live room for display.

The foregoing describes how the online streamer in the live room selects the plurality of products from the plurality of candidate products for recommendation to the user in the live room. The following describes a process of importing the plurality of candidate products into the candidate product library.

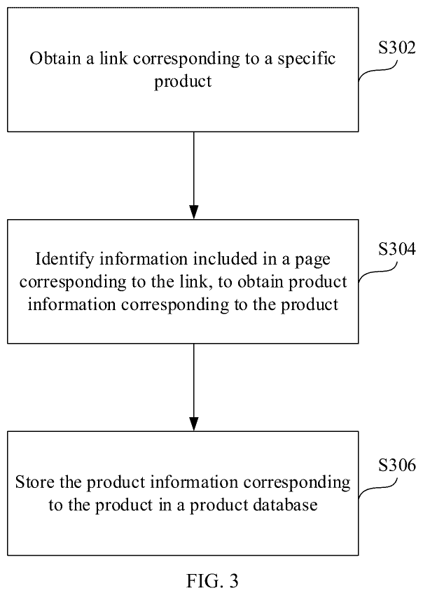

FIG. 3 is a flowchart of a product recommendation method in a live room according to an embodiment of the present disclosure.

According to some embodiments, a plurality of candidate products in a candidate product library (for example, the candidate product library in the method 100) are from a product database, and the product database is obtained by performing the following steps: step S302: obtaining a link corresponding to a specific product; step S304: identifying information included in a page corresponding to the link, to obtain product information corresponding to the product; and step S306: storing the product information corresponding to the product in the product database.

The product information corresponding to the product is automatically identified based on a product link. This can effectively simplify a process of importing the candidate products by the online streamer or the live platform without manually entering the product information, thereby implementing low-cost product import.

In some embodiments, the product information obtained by identifying the page corresponding to the link includes a product title and product model information. Specific imported product model information may be selected. For example, when the product is a garment, one or more pieces of product model information such as a color or a size of the garment may be selected for import; or when the product is a notebook computer, one or more pieces of product model information such as a screen size, a processor model, and memory space of the notebook computer may be selected for import.

In some embodiments, a process of identifying the product information in the page may be implemented by using a python script.

According to some embodiments, product information may alternatively be directly imported from another database in a batch import manner. To be specific, a plurality of candidate products in a candidate database (for example, the candidate database in the method 100) are from a product database, product information in the product database is imported from another database, product information in the another database is described according to a preset data rule, and the preset data rule is adapted to a data storage rule of the product database.

Therefore, the product information can be imported in batches, thereby further reducing costs of product import.

Similarly, specific imported product information may be selected, for example, the color and the size of the foregoing garment, and the screen size and the processor model of the foregoing notebook computer.

In some embodiments, the another database may be a database from a product supplier, and the preset data rule may be a CSV rule describing the product information. Transmission may be directly performed between the product supplier and the live platform by establishing a same preset data rule, thereby further increasing a product import speed.

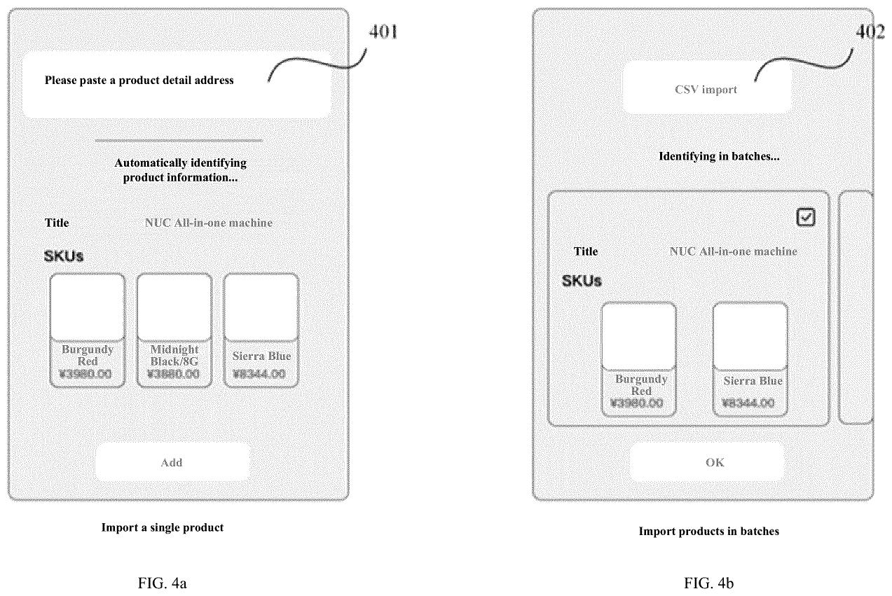

For example, FIG. 4a and FIG. 4b are schematic diagrams of product information import interfaces according to an embodiment of the present disclosure.

As shown in FIG. 4a, the interface is an example of an interface for importing product information. The interface includes a link area 401, and the area is used to add a link of a product to be imported. After the link of the product is obtained, information included in a page corresponding to the link may be identified by using a python script, to obtain product information corresponding to the product, for example, a product title, product model information, and price information that are shown in FIG. 4a. The product and the identified product information corresponding to the product are stored in the product database.

The interface shown in FIG. 4b is an example of an interface for importing product information in batches, and the interface includes a batch import object 402. The batch import object 402 may be selected to import product information corresponding to a plurality of products in the another database into the product database. Similarly, each piece of the product information corresponding to the products may include a product title, product model information, price information, and the like.

In addition, the method described in the present disclosure may alternatively include more steps or a combination thereof to enable the user to participate in product selection processes before livestreaming and in a livestreaming process. The following describes in detail a voting method in a live room with reference to the accompanying drawings.

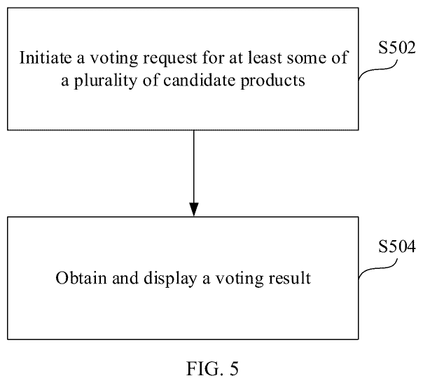

FIG. 5 is a flowchart of a product recommendation method in a live room according to an embodiment of the present disclosure.

According to some embodiments, the method 100 further includes: step S502: initiating a voting request for at least some of the plurality of candidate products; and step S504: obtaining and displaying a voting result, where the selecting at least one customizable product from the plurality of candidate products in step S104 includes: selecting the at least one customizable product from the at least some candidate products based on the voting result.

Therefore, users can participate in a product recommendation process of the live room. This helps the online streamer obtain feedback information of the users, to recommend a product to these users more accurately.

In some embodiments, voting on the at least some of the plurality of candidate products may be voting before livestreaming or in the livestreaming process. For example, before livestreaming, the user (for example, a fan user in the live room) may tap a voting entrance in a livestreaming preview push of the online streamer to enter a voting interface and select a product; or in the livestreaming process, the user may enter a voting interface by selecting a voting initiator in the live interface and select a product. In some embodiments, only the fan user in the live room can participate in voting on the plurality of products. A non-fan user needs to first meet a preset standard to become a fan user (for example, follow the live room), and then can participate in voting on the plurality of products.

In some embodiments, the initiating a voting request for at least some of the plurality of candidate products may refer to pushing the voting interface to a client, where the voting interface is used to display at least one to-be-voted product, so that the fan user can enter and send a voting selection by using the voting interface.

The voting selection of the user for the at least one product is sent to the online streamer in the live room, and the online streamer can adjust a recommended product (for example, the customizable product in the method 100) based on a result of the voting selection. For example, the online streamer may remove a product with a small quantity of user voting selections, and reserve a product with a large quantity of user voting selections. In addition, the online streamer may alternatively reselect a new product from the plurality of candidate products to replace the product with a low quantity of user voting selections.

According to some embodiments, the method 100 further includes: obtaining the voting result again at a preset time interval after the voting result is obtained; and displaying the voting result that is obtained again. Specifically, voting form data may be refreshed at a preset time interval, to obtain refreshed voting selections. Therefore, the online streamer in the live room can obtain a feedback of the user voting selection in real time, and quickly adjust the recommended product.

In some embodiments, the preset time interval is 2 s to 5 s.

According to some embodiments, the method 100 further includes: obtaining the voting result after livestreaming content of the live room ends, and displaying the voting result obtained after livestreaming ends. In other words, the online streamer in the live room may obtain a sum of results of all voting selections during this time of livestreaming after the livestreaming content ends, thereby more clearly understanding requirements of users for a product, and more accurately recommending a product in subsequent livestreaming.

In some embodiments, the voting result obtained after livestreaming ends further includes a change trend of a plurality of voting selections. The online streamer can more accurately understand a change of a user requirement based on the change trend, and correspondingly adjust a recommendation policy.

According to some embodiments, the method 100 is applicable to an online streamer terminal device or a server computing system.

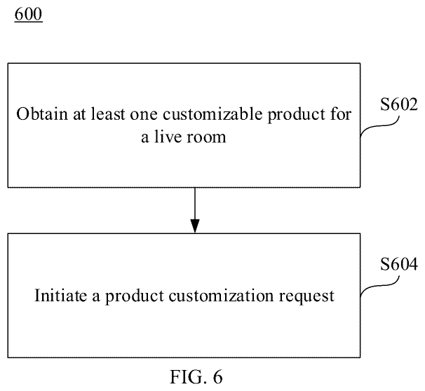

FIG. 6 is a flowchart of a product customization method 600 in a live room according to an embodiment of the present disclosure.

As shown in FIG. 6, the method 600 includes: step S602: obtaining at least one customizable product for the live room; and step S604: initiating a product customization request, where the product customization request includes a first customized product selected from the at least one customizable product and first customization information of the first customized product.

Therefore, a user can customize a customizable product in the live room, to obtain a product that matches a requirement of the user better, thereby increasing a product transaction conversion rate of the live room.

When the method 600 is performed by a user terminal device in the live room, the at least one customizable product for the live room is pushed by a server computing system to the user terminal device through broadcasting, and is obtained by the user terminal device. Information about the at least one customizable product is parsed by the user terminal device and cached in the user terminal device (for example, cached in a JSON format).

When the user in the live room wants to start customizing a product, the user may tap, for example, a product customization object (for example, a button) in a page of the live room. In response to tapping on the product customization object in the page of the live room, the user terminal device may quickly open a product customization page based on an identifier of the current live room and the information about the customizable product (for example, data information in the JSON format) that is cached in advance, to respond to the product customization page in real time.

According to some embodiments, the method 600 further includes: initiating a product customization update request, where the product customization update request includes a second customized product selected from the at least one customizable product and second customization information of the second customized product, and the second customized product is different from the first customized product and/or the second customization information is different from the first customization information.

In other words, in some cases, although the user wants to customize a particular pattern or particular text, the user may not be interested in a current customizable product, and therefore, the user may be further provided with a plurality of customizable products for switching. Specifically, the plurality of customizable products may be selected from the candidate products. When the user in the live room is not interested in the current customizable product, the user can switch to customize another customizable product in the plurality of customizable products. In addition, the user may also switch customization information of a product (for example, switch from customization of text information to customization of the picture information), thereby further enriching selections of the user.

In some embodiments, when the user in the live room wants to replace the customized product, the user may tap, for example, a product switching object (for example, a button) in the page of the live room. In response to tapping on the product switching object in the page of the live room, the user terminal device may switch to customization of the another customizable product, and refresh the product customization page based on a difference between data of the another customizable product and data of the original customizable product.

In some embodiments, priorities of the plurality of customizable products may be specified by the online streamer in the live room, that is, a customizable product having a higher priority is first recommended to the user. When the user is not interested in the current customizable product, the user may switch to a customizable product having a highest priority in other customizable products. In some other embodiments, the plurality of customizable products are recommended to the user in a random sequence, that is, when the user is not interested in the current customizable product, the user may switch to a random customizable product in the other customizable products.

In some embodiments, the priorities of the plurality of customizable products are determined based on recommendation indicators of the plurality of customizable products.

According to some embodiments, the customization information includes at least one of text information, picture information, product size information, or product color information. Expected text may be added to the product for the user by customizing the text information, and an expected picture may be added to the product for the user by customizing the picture information. In addition, the product size information and the product color information may be customized to replace a size and an appearance color of the product for the user, thereby expanding selection space of the user.

For example, when the user wants to customize the text information, the user may tap a text editing object (for example, text itself) to pop up an input keyboard. When the user completes input, the customized text information is stored in a local cache of the user terminal device, and is bound to a page identifier of the user terminal device to identify that the customized text information corresponds to the user terminal device.

In some embodiments, the customized product may be sent to the server computing system for display in the live room. Another user may purchase the displayed product or continue to customize the displayed product.

In addition, the user may alternatively purchase the customized product directly. Specifically, according to some embodiments, a purchase transaction for the customized product is initiated in response to receiving a purchase request for the customized product, for example, order detail information is sent to the server computing system. The order detail information includes original product information and customization information that is locally stored in the user terminal device and that is obtained after the user performs customization. The order detail information is sent to a corresponding purchase link, and an ordering page for the customized product is initiated for payment and transaction by the user. Therefore, an operation required for ordering by the user can be simplified, and a click conversion rate of the product can be increased.

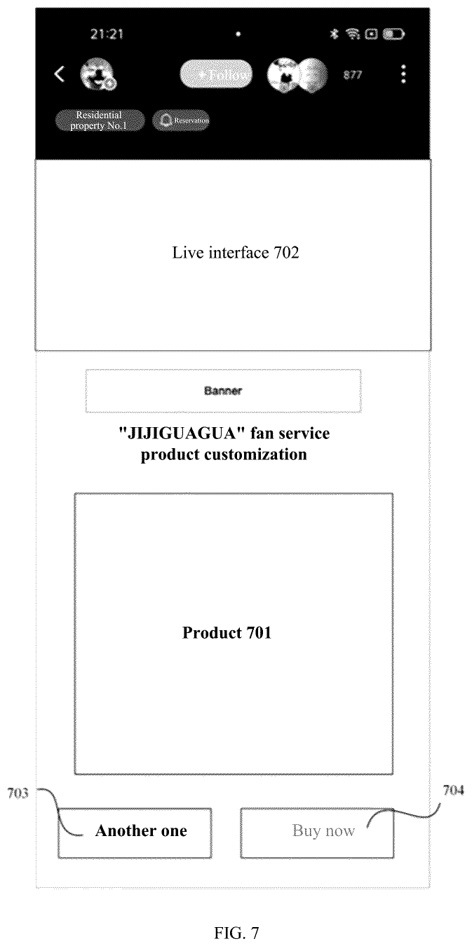

For example, FIG. 7 is a schematic diagram of a product customization service interface according to an embodiment of the present disclosure.

As shown in FIG. 7, the product customization service interface includes a product 701, a live interface 702, a switching object 703, and a purchase object 704. The live interface 702 displays livestreaming content that is being performed by the online streamer in the live room, and the product 701 is a customized product selected by the online streamer in the live room (for example, the foregoing first customized product). Information about the customized product is cached in a client device. When the user sends the product customization request, the product customization service interface can be constructed based on the identifier of the live room, data of the livestreaming content, and the cached information of the customized product.

When the user selects the switching object 703, a new customized product (for example, the foregoing second customized product) is used to replace the product 701.

When the user selects the purchase object 704, product information and customization information of the user are exported to a purchase link, and a purchase interface is opened for payment by the user to complete purchasing.

According to some embodiments, the method 600 further includes: receiving a voting request; and sending a voting result for the voting request, where the voting result includes a selection on at least one of the plurality of candidate products, and at least one customizable product in the live room is selected from the plurality of candidate products based on the voting result. Therefore, users can participate in a product recommendation process of the live room. This helps the online streamer obtain feedback information of the users, to recommend a product to these users more accurately.

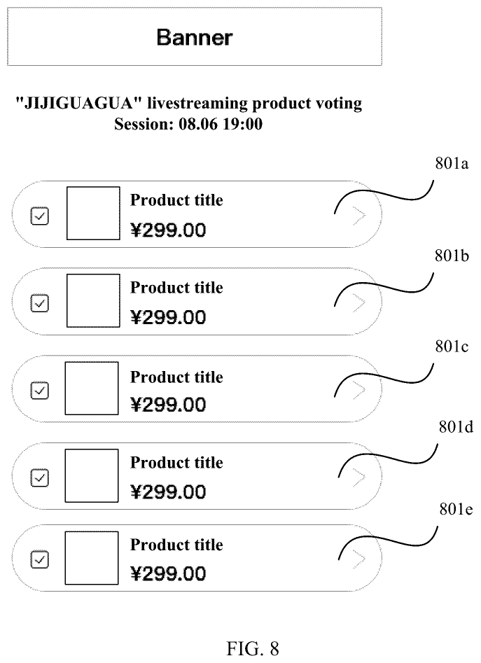

For example, FIG. 8 is a schematic diagram of a product voting interface according to an embodiment of the present disclosure.

As shown in FIG. 8, the product voting interface includes a plurality of products 801a, 801b, 801c, 801d, and 801e. The user can perform voting selection on one or more of the products. The voting selection is that a selection box on a left side of a product is updated based on unidirectional data flow logic to change the selection box to be in a selected state. After the user completes voting, the voting selection is sent in a form of compressed form data to, for example, the server computing system of the live platform, to be further provided to the online streamer for product adjustment. After the voting selection is sent to the server computing system, the voting interface is refreshed to prompt the user that the voting selection has been sent.

The voting interface may be a multi-platform interface based on specific layout logic and an operation rule. In some embodiments, expected layout logic and operation logic may be implemented between different user equipments according to a customized JSON description rule by using a Flexbox layout engine.

In some embodiments, when the user initiates the voting request, the identifier of the live room may be sent to the server computing system of the live platform to request corresponding layout protocol interface and data interface, and corresponding data is obtained through the layout protocol interface and the data interface and the voting interface is constructed for display to the user.

In some embodiments, the user may further select the plurality of products 801a, 801b, 801c, 801d, and 801e to understand detailed descriptions of corresponding products. For example, the user may enter a description interface of the product by tapping a preset arrow object, to help the user better understand detailed information of the product.

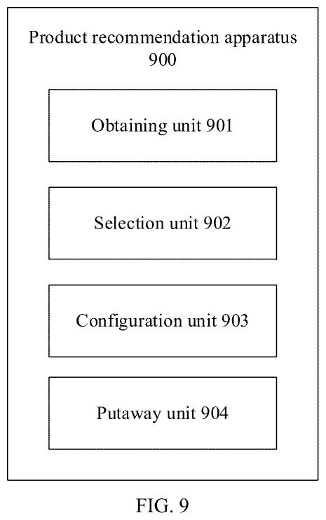

FIG. 9 is a block diagram of a product recommendation apparatus 900 in a live room according to an embodiment of the present disclosure.

As shown in FIG. 9, the apparatus 900 includes: an obtaining unit 901, where the obtaining unit is configured to obtain a candidate product library for the live room, and the candidate product library includes a plurality of candidate products; a selection unit 902, where the selection unit is configured to select at least one customizable product from the plurality of candidate products; a configuration unit 903, where the configuration unit is configured to configure customizable information of the at least one customizable product; and a putaway unit 904, where the putaway unit is configured to add the at least one customizable product configured with the customizable information to the live room, to perform product customization based on a product customization request.

The product recommendation apparatus 900 may be configured to perform an operation similar to the foregoing method 100. Details are not described herein again.

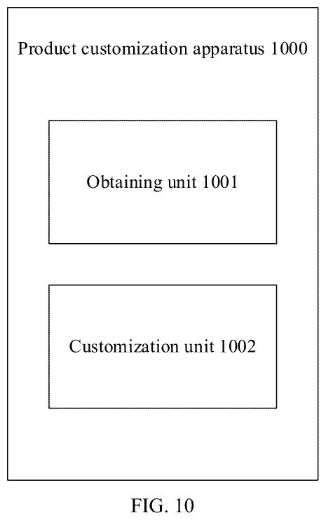

FIG. 10 is a block diagram of a product customization apparatus 1000 in a live room according to an embodiment of the present disclosure.

As shown in FIG. 10, the apparatus 1000 includes: an obtaining unit 1001, where the obtaining unit is configured to obtain at least one customizable product for the live room; and a customization unit 1002, where the customization unit is configured to initiate a product customization request, where the product customization request includes a first customized product selected from the at least one customizable product and first customization information of the first customized product.

The product customization apparatus 1000 may be configured to perform an operation similar to the foregoing method 600. Details are not described herein again.

According to another aspect of the present disclosure, an electronic device is further provided, including: at least one processor; and a memory communicatively connected to the at least one processor, where the memory stores a computer program, and the foregoing method is implemented when the computer program is executed by the at least one processor.

According to another aspect of the present disclosure, a non-transitory computer-readable storage medium storing a computer program is further provided, where the foregoing method is implemented when the computer program is executed by a processor.

According to another aspect of the present disclosure, a computer program product is further provided, including a computer program, where the foregoing method is implemented when the computer program is executed by a processor.

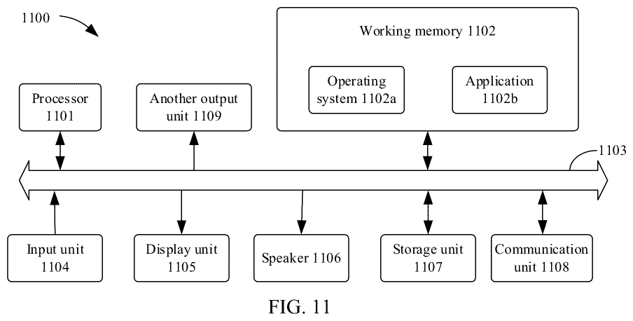

FIG. 11 is a block diagram of a structure of an electronic device 1100 that can be used as a server computing system or a client in the present disclosure. The electronic device 1100 is an example of a hardware device that can be applied to each aspect of the present disclosure. The electronic device may be different types of computer devices, such as a laptop computer, a desktop computer, a workbench, a personal digital assistant, a server computing system, a blade server, a mainframe computer, and another suitable computer. The electronic device may further represent mobile apparatuses in various forms, such as a personal digital assistant, a cellular phone, a smart phone, a wearable device, and another similar computing apparatus. The components shown herein, connections and relationships thereof, and functions thereof are merely examples and are not intended to limit the implementations of the present disclosure as described and/or required herein.

As shown in FIG. 11, the electronic device 1100 may include at least one processor 1101, a working memory 1102, an input unit 1104, a display unit 1105, a speaker 1106, a storage unit 1107, a communication unit 1108, and another output unit 1109 that can communicate with each other by using a system bus 1103.

The processor 1101 may be one or more processing units, and all the processing units may include one or more computing units or a plurality of cores. The processor 1101 may be implemented as one or more microprocessors, microcomputers, microcontrollers, digital signal processors, central processing units, state machines, logic circuits, and/or any device that operates a signal based on an operation instruction. The processor 1101 may be configured to obtain and execute computer-readable instructions stored in the working memory 1102, the storage unit 1107, or another computer-readable medium, such as program code of an operating system 1102a and program code of an application 1102b.

The working memory 1102 and the storage unit 1107 are examples of computer-readable storage media configured to store instructions, and the instructions are executed by the processor 1101 to implement the foregoing various functions. The working memory 1102 may include a volatile memory and a non-volatile memory (for example, a RAM or a ROM). In addition, the storage unit 1107 may include a hard disk drive, a solid-state drive, and a removable medium, and include an external removable drive, a memory card, a flash memory, a floppy disk, an optical disc (for example, a CD or a DVD), a storage array, a network attached storage, a storage area network, and the like. Both the working memory 1102 and the storage unit 1107 may be collectively referred to as memories or computer-readable storage media herein, and may be non-transient media that can store computer-readable and processor-executable program instructions as computer program code. The computer program code may be executed by the processor 1101 as a specific machine configured to implement the operations and the functions described in the examples herein.

The input unit 1106 may be any type of device that can input information to the electronic device 1100. The input unit 1106 may receive an input number or character information and generate a key signal input related to user settings and/or function control of the electronic device, and may include but is not limited to a mouse, a keyboard, a touchscreen, a trackpad, a trackball, an operation lever, a microphone, and/or a remote controller. The output unit may be any type of device that can present information, and may include but is not limited to the display unit 1105, the speaker 1106, and the another output unit 1109. The another output unit 1109 may include but is not limited to a video/audio output terminal device, a vibrator, and/or a printer. The communication unit 1108 allows the electronic device 1100 to exchange information/data with another device by using a computer network such as the Internet and/or various telecommunication networks, and may include but is not limited to a modem, a network interface card, an infrared communication device, a wireless communication transceiver, and/or a chipset, for example, a Bluetooth™ device, a 1302.11 device, a Wi-Fi device, a WiMax device, and/or a cellular communication device.

The application 1102b in the working memory 1102 may be loaded to perform the foregoing methods and processing, for example, step S102 to step S108 in FIG. 1. For example, in some embodiments, the product recommendation method in a live room may be implemented as a computer software program, and the computer software program is tangibly included in a machine-readable medium, for example, the storage unit 1107. In some embodiments, the computer program may be partially or completely loaded and/or installed on the electronic device 1100 by the storage unit 1107 and/or the communication unit 1108. When the computer program is loaded and is executed by the processor 1101, one or more steps of the foregoing product recommendation method in a live room may be performed. Alternatively, in another embodiment, the processor 1101 may be configured in any other suitable manner (for example, by using firmware) to perform the product recommendation method in a live room.

Various implementations of the foregoing system and technology in this specification may be implemented in a digital electronic circuit system, an integrated circuit system, a field programmable gate array (FPGA), an application-specific integrated circuit (ASIC), an application-specific standard product (ASSP), a system-on-chip (SOC), a complex programmable logic device (CPLD), computer hardware, firmware, software, and/or a combination thereof. These implementations may be implemented in one or more computer programs, the one or more computer programs may be executed and/or interpreted on a programmable system including at least one programmable processor, and the programmable processor may be an application-specific programmable processor or a general-purpose programmable processor that may receive data and instructions from a storage system, at least one input apparatus, and at least one output apparatus, and transmit data and instructions to the storage system, the at least one input apparatus, and the at least one output apparatus.

Program code used to implement the methods of the present disclosure may be written in any combination of one or more programming languages. The program code may be provided to a processor or a controller of a general-purpose computer, an application-specific computer, or another programmable data processing apparatus, so that when the program code is executed by the processor or the controller, the functions/operations specified in the flowcharts and/or the block diagrams are implemented. The program code may be completely executed on a machine, partially executed on a machine, partially executed on a machine and partially executed on a remote machine as a stand-alone package, or completely executed on a remote machine or a server.

In the context of the present disclosure, the machine-readable medium may be a tangible medium, and may include or store a program for use by or in combination with an instruction execution system, apparatus, or device. The machine-readable medium may be a machine-readable signal medium or a machine-readable storage medium. The machine-readable medium may include but is not limited to an electronic, magnetic, optical, electromagnetic, infrared, or semiconductor system, apparatus, or device, or any suitable combination of the foregoing content. A more specific example of the machine-readable storage medium includes an electrical connection based on one or more lines, a portable computer disk, a hard disk, a random access memory (RAM), a read-only memory (ROM), an erasable programmable read-only memory (EPROM or flash memory), an optical fiber, a convenient compact disc read-only memory (CD-ROM), an optical storage device, a magnetic storage device, or any suitable combination of the foregoing content.

To provide interaction with a user, the system and the technology described herein may be implemented on a computer. The computer has a display apparatus (for example, a CRT (cathode ray tube) or an LCD (liquid crystal display) monitor) configured to display information to the user, and a keyboard and a pointing apparatus (for example, a mouse or a trackball), where the user may provide an input to the computer by using the keyboard and the pointing apparatus. Another type of apparatus may alternatively be configured to provide interaction with the user. For example, a feedback provided to the user may be a sensing feedback in any form (for example, a visual feedback, an auditory feedback, or a tactile feedback); and an input from the user may be received in any form (including a sound input, a voice input, or a tactile input).

The system and the technology described herein may be implemented in a computing system (for example, as a data server) that includes a background component, a computing system (for example, an application server) that includes a middleware component, a computing system (for example, a user computer having a graphical user interface or a web browser, where the user may interact, by using the graphical user interface or the web browser, with the implementations of the system and the technology described herein) that includes a front-end component, or a computing system that includes any combination of the background component, the middleware component, or the front-end component. Components of the system may be interconnected through digital data communication in any form or medium (for example, a communication network). Examples of the communication network include a local area network (LAN), a wide area network (WAN), and the Internet.

The computer system may include a client and a server. The client and the server are usually far away from each other and usually interact with each other by using the communication network. A client-server relationship is generated by computer programs running on corresponding computers and having the client-server relationship with each other.

It should be understood that the steps may be reordered, added, or deleted by using the foregoing procedures in various forms. For example, the steps described in the present disclosure may be performed in parallel, in sequence, or in different sequences, provided that a result expected by the technical solution of the present disclosure can be implemented. This is not limited herein.

Although the embodiments or examples of the present disclosure have been described with reference to the accompanying drawings, it should be understood that the foregoing methods, systems, and devices are merely example embodiments or examples, and the scope of the present disclosure is not limited by these embodiments or examples, but is merely limited by the claims after authorization and the equivalent scope thereof. Various elements in the embodiments or examples may be omitted or replaced by equivalent elements thereof. In addition, the steps may be performed in a sequence different from that described in the present disclosure. Further, the various elements in the embodiments or examples may be combined in various manners. It is important that as technologies evolve, many elements described herein may be replaced with equivalent elements that appear after the present disclosure.

What is claimed is:

1. A method of implementing livestreaming, comprising:
generating a candidate product library associated with a live room based on monitoring interaction data associated with products, wherein the candidate product library comprises a plurality of candidate products, and wherein the live room is configured to implement livestreaming by a streamer terminal device associated with an online streamer;
generating recommendation indicators corresponding to the plurality of candidate products based on historical interaction data of the plurality of candidate products;
causing to present the recommendation indicators on the streamer terminal device;
selecting at least one customizable product from the plurality of candidate products based at least in part on the recommendation indicators;
configuring customizable information of the at least one customizable product; and
adding the at least one customizable product configured with the customizable information to the live room for pushing to one or more audience terminal devices during a livestreaming process.

2. The method according to claim 1, further comprising:
determining user portrait information associated with the live room during the livestreaming process based on behavior data of one or more users who fall within an intersection between fans of the live room and real-time viewers in the live room; and
updating the candidate product library based on the user portrait information associated with the live room during the livestreaming process.

3. The method according to claim 2, further comprising:
performing product selection or product replacement in the live room based on the updated candidate product library during the livestreaming process.

4. The method according to claim 1, wherein the customizable information comprises at least one of text information, picture information, product size information, or product color information.

5. The method according to claim 1, wherein the historical interaction data of the plurality of candidate products comprises at least one of exposure rates, favorite rates, click conversion rates, and user feedback information of the plurality of candidate products.

6. The method according to claim 1, wherein the recommendation indicators comprise recommendation scores or recommendation reasons corresponding to the plurality of candidate products.

7. The method according to claim 1, further comprising:
automatically identifying and obtaining product information about the plurality of candidate products in the candidate product library from a product database.

8. The method according to claim 7, wherein product information in the product database is imported from another database, wherein product information in the another database is created according to a preset data rule, and wherein the preset data rule is adapted to a data storage rule of the product database.

9. The method according to claim 1, further comprising:
initiating a voting request for at least some of the plurality of candidate products; and
obtaining and causing to display a voting result.

10. The method according to claim 9, wherein the selecting at least one customizable product from the plurality of candidate products further comprises:
selecting the at least one customizable product from the at least some of the plurality of candidate products based on the voting result.

11. The method according to claim 9, further comprising:
obtaining another voting result again at a preset time interval from the voting result being obtained; and
causing to display the another voting result.

12. The method according to claim 1, further comprising:
causing to display an interface on the one or more audience terminal devices, wherein the interface comprises a first area of displaying livestreaming content being performed by the online streamer and a second area of displaying the at least one customizable product.

13. A computing system of implementing livestreaming, comprising:
at least one processor; and
at least one memory communicatively coupled to the at least one processor and comprising computer-readable instructions that upon execution by the at least one processor cause the at least one processor to perform operations comprising:
generating a candidate product library associated with a live room based on monitoring interaction data associated with products, wherein the candidate product library comprises a plurality of candidate products, and wherein the live room is configured to implement livestreaming by a streamer terminal device associated with an online streamer;
generating recommendation indicators corresponding to the plurality of candidate products based on historical interaction data of the plurality of candidate products;
causing to present the recommendation indicators on the streamer terminal device;
selecting at least one customizable product from the plurality of candidate products based at least in part on the recommendation indicators;
configuring customizable information of the at least one customizable product; and
adding the at least one customizable product configured with the customizable information to the live room for pushing to one or more audience terminal devices during a livestreaming process.

14. The computing system according to claim 13, the operations further comprising:
determining user portrait information associated with the live room during the livestreaming process based on behavior data of one or more users who fall within an intersection between fans of the live room and real-time viewers in the live room; and
updating the candidate product library based on the user portrait information associated with the live room during the livestreaming process.

15. The computing system according to claim 14, the operations further comprising:
performing product selection or product replacement in the live room based on the updated candidate product library during the livestreaming process.

16. The computing system according to claim 13, wherein the historical interaction data of the plurality of candidate products comprises at least one of exposure rates, favorite rates, click conversion rates, and user feedback information of the plurality of candidate products.

17. The computing system according to claim 13, the operations further comprising:
automatically identifying and obtaining product information about the plurality of candidate products in the candidate product library from a product database.

18. The computing system according to claim 13, the operations further comprising:
initiating a voting request for at least some of the plurality of candidate products;
obtaining and causing to display a voting result; and
selecting the at least one customizable product from the at least some of the plurality of candidate products based on the voting result.

19. A non-transitory computer-readable storage medium, storing computer-readable instructions that upon execution by a processor cause the processor to implement operations comprising:
generating a candidate product library associated with a live room based on monitoring interaction data associated with products, wherein the candidate product library comprises a plurality of candidate products, and wherein the live room is configured to implement livestreaming by a streamer terminal device associated with an online streamer;
generating recommendation indicators corresponding to the plurality of candidate products based on historical interaction data of the plurality of candidate products;
causing to present the recommendation indicators on the streamer terminal device;
selecting at least one customizable product from the plurality of candidate products based at least in part on the recommendation indicators;
configuring customizable information of the at least one customizable product; and
adding the at least one customizable product configured with the customizable information to the live room for pushing to one or more audience terminal devices during a livestreaming process.

20. The non-transitory computer-readable storage medium according to claim 19, the operations further comprising:
determining user portrait information associated with the live room during the livestreaming process based on behavior data of one or more users who fall within an intersection between fans of the live room and real-time viewers in the live room;
updating the candidate product library based on the user portrait information associated with the live room during the livestreaming process; and
performing product selection or product replacement in the live room based on the updated candidate product library during the livestreaming process.
